(19) United States
(12) Patent Application Publication
(10) Pub. No.: US 2003/0069976 A1
(43) Pub. Date: Apr. 10, 2003

(54) Intelligent round robining

(75) Inventors: Craig Boyle, Auburn, MA (US); Ajit Nair, Framingham, MA (US); Donghai Ma, Acton, MA (US)

Correspondence Address: Fogg, Slifer & Polglaze, P.A., P.O. Box 581009, Minneapolis, MN, 55458-1009, US

(73) Assignee: ADC Telecommunications, Inc.

(21) Appl. No.: 09/971,828

(22) Filed: Oct. 5, 2001

(51) Int. Cl. G06F 15/16

(52) U.S. Cl. 709/227

(57) ABSTRACT

Intelligent round robin assignment of users to subnets within an internet service provider includes determining an assignment criteria for assigning users to the ISP, and assigning users to the subnet that best fits the assignment criteria. Assignment criteria are determined based on any number of factors including available resources and user history.

The present invention relates generally to telecommunications, and more specifically to assignment of users to internet service providers.

### BACKGROUND

Assignment of customers, clients, or devices to subnets within an internet service provider is typically accomplished by filling a subnet as it is needed. When a subnet is full, another subnet is activated and begins to fill. ISPs often have multiple subnets, some of which may be completely unused except in cases of near capacity use of the system. However, as the limits of subnet capacity within an individual subnet are reached, performance can begin to suffer, resulting in slow access or download times, or limited bandwidth.

Subnets are portions of a network sharing network addresses with other portions of the network. Each subnet is typically assigned a number. A number of subnets together form a network.

Further, with large numbers of users, and automated assignment of users to subnets within an ISP, it is often difficult if not impossible to determine the potential effects of adding another user to a subnet, or to determine whether the user would be better served by another subnet.

Therefore, there is needed in the art a way to allocate users among the various subnets of an ISP.

### SUMMARY

In one embodiment, a method for assigning users to an internet service provider (ISP) includes monitoring subnet usage within the ISP for a number of subnets, receiving a request from a user for assignment within the ISP, and assigning the user to a subnet according to a distributed usage plan.

In another embodiment, a method includes monitoring subnet usage within an internet service provider (ISP), receiving a request for assignment to the ISP, and determining current assignment criteria for assignment of a user to a subnet within the ISP. Once the assignment criteria is determined, in one embodiment according to a predetermined plan, a best subnet assignment is determined based on the current assignment criteria, and the user is assigned to the best subnet.

In yet another embodiment, a computer program for performing a method includes instructions for causing a computer to monitor subnet usage for a number of subnets within an ISP. When an assignment request is received from a user, a subnet is assigned according to a distributed usage plan.

In still another embodiment, a system for assigning users to an ISP subnet includes an ISP server connectable to a subscriber network, the ISP server having memory, storage, and a processor, and a computer program, stored in storage and operable in the memory, the computer program performing intelligent assignment of users to the ISP according to a predetermined assignment plan.

In another embodiment, a computer system for administering an internet service provider includes a computer having a processor, a main memory, a mass storage device, and a network interface, and a computer program stored in storage and operable in the main memory by the processor. The program monitors subnet usage within the ISP, and receives requests for assignment of users to the ISP. The program applies current assignment criteria for assignment of a user to a subnet within the ISP according to a determined best subnet assignment based on the current assignment criteria.

Other embodiments are described and claimed.

### BRIEF DESCRIPTION OF THE DRAWINGS

FIG. 1 is a flow chart diagram of a method according to one embodiment of the present invention;

FIG. 2 is a flow chart diagram of a method according to another embodiment of the present invention;

FIG. 3A is a block diagram of a computer according to one embodiment of the present invention;

FIG. 3B is a block diagram of a computer according to another embodiment of the present invention;

FIG. 4 is a flow chart diagram of a method according to yet another embodiment of the present invention; and

FIG. 5 is a flow chart diagram of a method according to another embodiment of the present invention.

### DETAILED DESCRIPTION

In the following detailed description of the embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present invention, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Referring to FIG. 1, a flow chart describing a method 100 for assigning users to a subnet within an internet service provider is shown. Method 100 comprises receiving a request for assignment of an internet address for usage on a network in block 102, checking network status for the ISP to which the user requesting assignment is registered in block 104, and assigning the user to a subnet based on the status of the ISP and the subnets of the particular ISP in block 106. The request received in one embodiment includes information identifying the particular customer provided equipment (CPE), cable modem, modem, DSL modem, or the like as well as the particular ISP to which the equipment or user subscribes or is registered with. Once the request is received, and the particular ISP for the requester is identified, a check is made of the subnet status of the subnets of the particular ISP to which the request is directed.

In one embodiment, checking ISP subnet status includes monitoring subnet and ISP utilization, as well as subnet usage. Many different usage standards are monitored in various embodiments. By way of example only, and not by way of limitation, monitored parameters include number of users, number of available addresses, bandwidth used (both instantaneous and over intervals), available bandwidth, geographic area, expected usage, previous usage of individual or group requesters, time-averaged usage, and the like. Based on the determined network usage, an intelligent round robin assignment of users to ISP subnets is accomplished.

For example, when a request is received to assign a user within an ISP, software employing the methods described above is used to determine the best subnet assignment for the user based on the criteria for assignment being applied at the time of the request. In one example, suppose an ISP wishes to assign users to its subnets on the basis of available addresses in the subnets. The software determines, for all subnets within the ISP, which subnet has the most number of available addresses, and the user is assigned to that subnet.

In another example, the criteria for assignment to a subnet is based on bandwidth usage. Monitoring is performed over time of the bandwidth usage in each subnet, such as 5 minute average bandwidth usage, per user bandwidth average usage, or the like. When a request is received for assignment within a network, the user is assigned to the subnet with the lowest 5 minute average bandwidth usage. Such assignments serve to level the load on the subnets of a particular ISP.

In another embodiment, when total subnet usage is nearing capacity, as determined by one or more of the methods described above, the system notifies the ISP that its usage is nearing capacity. This allows the ISP to dynamically request an additional subnet or additional subnets for use. This prevents frustrated users who are unable to access an ISP due to availability limitations.

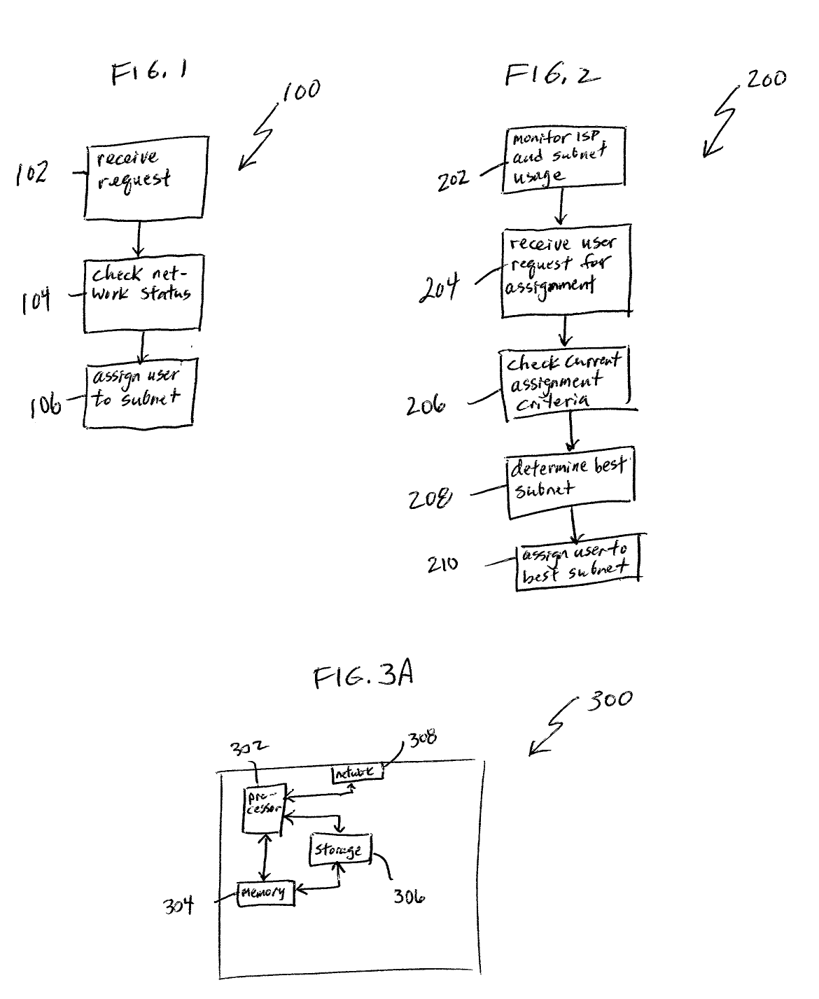

Another method 200 for assigning a user to an ISP is shown in flow chart diagram in FIG. 2. Method 200 comprises monitoring ISP and subnet usage in block 202, receiving a user request for assignment within an ISP in block 204, and checking current assignment criteria in block 206. In block 208, the best or appropriate subnet within an ISP is determined based on the current assignment criteria. The user is assigned to the determined best subnet in block 210.

Monitoring of ISP and subnet usage is accomplished in one embodiment using the methods described above. The criteria for assignment to a subnet within an ISP may change during the course of operation of the network. Each request in one embodiment is subject to the assignment criteria at the time the request is made.

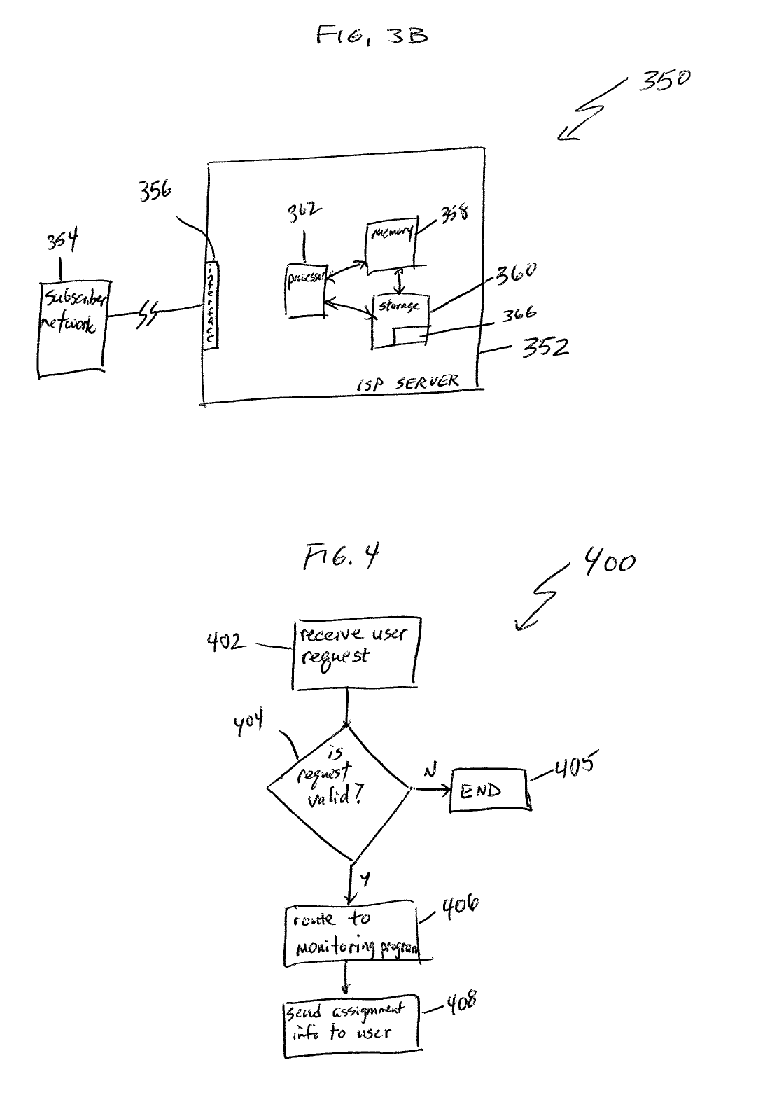

A computer system 300 for administering an ISP is shown in FIG. 3A. Computer system 300 comprises a computer having a processor 302, main memory 304 such as random access memory, mass storage 306 such as a hard drive, CD-ROM drive, DVD drive or combination thereof, and a network interface 308. The mass storage stores a program for execution by the processor. The program in one embodiment is a program comprising instructions for causing the computer to perform a method such as that described above.

Another embodiment 350 of a system for assigning users to an internet service provider subnet is shown in FIG. 3B. System 350 comprises an ISP server 352 connectable to a subscriber network 354 via a network interface 356. The ISP server has central memory 358, storage 360, and a processor 362. An assignment database 364 resides in storage 360, or other external storage such as a CD-ROM, external hard drive, or the like. This assignment database contains information concerning all of the assignment criteria for use with an ISP. Multiple assignment databases are stored for multiple ISPs in one embodiment. A computer program 366 is stored in storage 360 and is operable in the memory 358 by the processor 360 to allow monitoring of subnet usage for a plurality of subnets within the ISP. The network interface 356 receives an assignment request from a user, and the assignment database corresponding to the ISP to which the received request is addressed is consulted, given the current distributed usage plan or criteria put in place by an operator of the system, or by another predefined protocol. The user is assigned to a subnet within the ISP according to the protocol.

In one embodiment, the systems 300 and 350 use a router or other external communications apparatus to receive and route user requests for assignments to ISPs and subnets within ISPs. In another embodiment, determining a best subnet assignment within an ISP includes applying the current assignment criteria to each specific request, and determining for each request which available subnet within an ISP best fits the instantaneous criteria. In another embodiment, past usage data for individual users is maintained in a database or other lookup format, and each user's history is consulted in determining which subnet best fits for assignment purposes. For example, in one embodiment, a particular user is associated with very high bandwidth usage. A request for access from this user triggers a change in the subnet assignment scheme and criteria so that assignment is based on available bandwidth, available expected bandwidth, or the like. The dynamic changing of assignment criteria allows the systems to perform effective monitored assignment of users to subnets to most efficiently use the capabilities of the network.

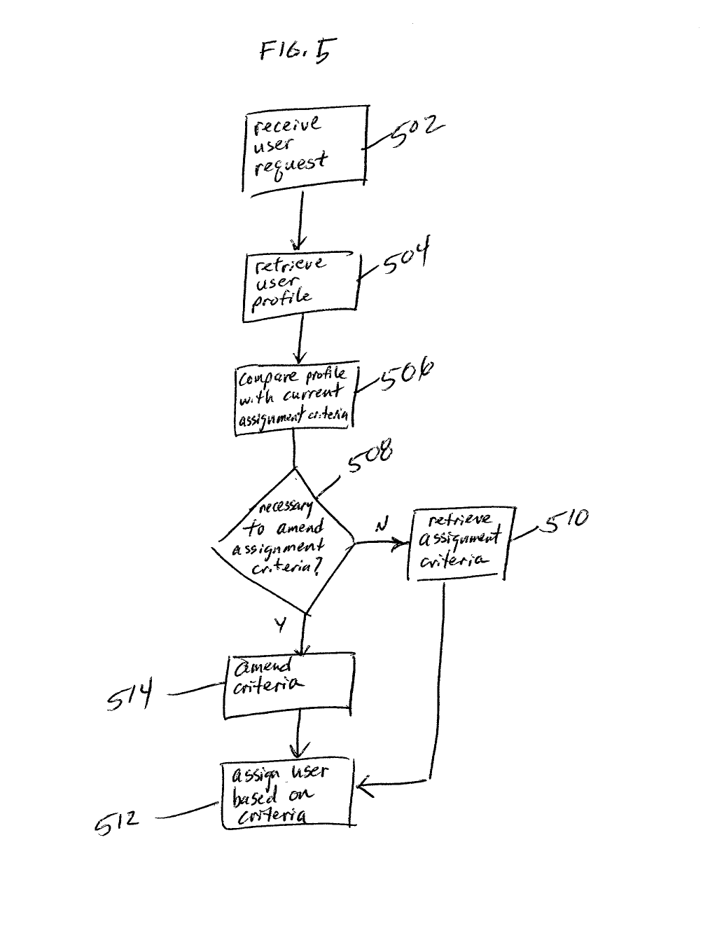

A method 400 for operating a system such as systems 300 or 350 is shown in flow chart form in FIG. 4. In method 400, a request is received from a user via the network interface in block 402. The request is checked to determine if the request is valid in block 404. The process by which a request is validated is known in the art, and will not be described further herein. If the request is not valid, process flow terminates in block 405. Once the request is determined to be valid, it is routed to a program running a method such as those described above with respect to FIGS. 1 and 2. The program monitors ISP and subnet utilization, and determines assignment of the user to a subnet within the ISP in block 406. Information concerning the assignment of the user, such as addresses and other configuration information, are sent via the network interface to the user in block 408.

Another method 500 of assignment of users to a subnet within an ISP is shown in FIG. 5. Method 500 comprises receiving a user request for assignment to a particular ISP in block 502, and retrieving a user profile containing user profile information such as past usage statistics or the like in block 504. The user information and the current assignment criteria are compared in block 506, and it is determined whether the criteria need to be changed in decision block 508. If the criteria do not need to be changed, the current assignment criteria are retrieved in block 510, and the user is assigned to a subnet in block 512. If the criteria need to be changed, they are amended in block 514, and the user is assigned to a subnet in block 512.

The methods shown in FIGS. 1, 2, 4, and 5 may be implemented in whole or in part in various embodiments in a machine readable medium comprising machine readable instructions for causing a computer such as is shown in FIG. 3A or 3B to perform the methods. The computer programs run on the central processing unit 302 or 362 out of main memory 304 or 358, and may be transferred to main memory from permanent storage via disk drive or CD-ROM drive when stored on removable media or via a network connection 308 or 356 or modem connection when stored outside of the computer 300 or 350, or via other types of computer or machine readable media from which it can be read and utilized.

Such machine readable media may include software modules and computer programs. The computer programs may comprise multiple modules or objects to perform the methods in FIGS. 1, 2, 4, and 5 or the functions of various apparatuses of FIGS. 3A and 3B. The type of computer programming languages used to write the code may vary between procedural code type languages to object oriented languages. The files or objects need not have a one to one correspondence to the modules or method steps described depending on the desires of the programmer. Further, the method and apparatus may comprise combinations of software, hardware and firmware as is well known to those skilled in the art.

A system such as systems 300 or 350 described herein is operable on a network computer system that is responsible for administering multiple ISPs from a single location. Such a system includes in various embodiments a provisioning server running software that allows the provisioning server to allow connection of various CPEs, modems, and the like to one or more of a number of ISPs. Each ISP may have multiple subnets within its configuration, where each subnet allows connection of a certain number of users, a certain bandwidth of use, or the like.

Assigning new and returning users to one of a plurality of subnets for an ISP according to an intelligent scheme comprises actively or passively monitoring usage of subnets for an ISP. The monitoring in various embodiments is done on the basis of one or more of a number of factors, including by way of example only and not by way of limitation, geographic area, subnet usage, subnet availability, available bandwidth, available IP addresses, number of users, number of expected users, and the like. When a request is received for access, the end user must be assigned a subnet. The assignment is based on the monitored status of the ISP and its subnets. For example, if a request comes in, the system assigns to the subnet with the fewest number of users, or with the most currently available bandwidth, or with the most average available bandwidth based on the last 15 minutes of usage, or the like. Any criteria is acceptable, provided that it is monitored. In one embodiment, each successive user is simply assigned to the next subnet in a set of subnets from the last user, and each subsequent user is assigned to the next subnet, in a round robin fashion.

A system for accomplishing such a round robining uses a computer running a computer program, the computer program performing dynamic monitoring of the nature and type described above. The program actively monitors the various subnets of an individual ISP, or of multiple ISPs, and when a request for access is received to a specific ISP, the ISP subnets which are being monitored are filtered according to the criteria of subnet assignment, and the request is processed for assignment according to the assignment protocol. The system includes in one embodiment a computer running the program.

In one embodiment, the computer system is a configuration server. In another embodiment, the computer system is a provisioning server. In another embodiment, the computer system is a network computer system dedicated to ISP assignment, and is in communication with a configuration or other network server performing other network functions.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method for assigning users to an ISP, comprising:
monitoring subnet usage for a plurality of subnets within the ISP;
receiving an assignment request from a user; and
assigning a subnet according to a distributed usage plan.

2. The method of claim 1, wherein monitoring comprises:
monitoring available resources of the plurality of subnets within the ISP.

3. The method of claim 2, wherein monitoring further comprises:
dynamically checking resources.

4. The method of claim 1, wherein monitoring is performed by using one or more of number of users, number of available addresses, bandwidth used, instantaneous bandwidth usage, available bandwidth, geographic area, expected usage, previous usage, and time-averaged usage.

5. The method of claim 1, wherein the distributed usage plan comprises:
load leveling between the plurality of subnets

6. The method of claim 5, wherein load leveling comprises:
determining a best available subnet according to a current assignment criteria.

7. A method, comprising:
monitoring subnet usage within an internet service provider (ISP);
receiving a request for assignment to the ISP;
determining current assignment criteria for assignment of a user to a subnet within the ISP;
determining a best subnet assignment based on the current assignment criteria; and
assigning the user to the best subnet.

8. The method of claim 7, wherein monitoring comprises:
monitoring available resources of the plurality of subnets within the ISP.

9. The method of claim 8, wherein monitoring further comprises:
dynamically monitoring available resources.

10. The method of claim 7, wherein the current assignment criteria is determined from a predetermined combination of multiple criterions chosen from a group consisting of:
number of users, number of available addresses, bandwidth used, instantaneous bandwidth usage, available bandwidth, geographic area, expected usage, previous usage, and time-averaged usage.

11. The method of claim 7, wherein monitoring is performed by using one method of a group consisting of:
number of users, number of available addresses, bandwidth used, instantaneous bandwidth usage, available bandwidth, geographic area, expected usage, previous usage, and time-averaged usage.

12. The method of claim 7, wherein determining a best subnet assignment further comprises:
applying the current assignment criteria to the received request; and
determining which available subnet best fits the current assignment criteria.

13. The method of claim 12, wherein determining which available subnet best fits the current assignment criteria comprises:
reviewing past usage data for the user from which the request is received; and
applying past usage information as a predictor of future usage data in determining the best available subnet.

14. The method of claim 7, wherein determining a best subnet assignment further comprises:
retrieving stored usage information data of the user of the received request; and
dynamically updating assignment criteria based on the stored usage information.

15. A computer readable medium having instructions stored thereon for causing a computer to perform a method comprising:
monitoring subnet usage for a plurality of subnets within the ISP;
receiving an assignment request from a user; and
assigning a subnet according to a distributed usage plan.

16. The computer readable medium of claim 15, wherein monitoring comprises:
monitoring available resources of the plurality of subnets within the ISP.

17. The computer readable medium of claim 16, wherein monitoring further comprises:
dynamically checking resources.

18. The computer readable medium of claim 15, wherein monitoring is performed by using one or more of number of users, number of available addresses, bandwidth used, instantaneous bandwidth usage, available bandwidth, geographic area, expected usage, previous usage, and time-averaged usage.

19. A computer readable medium having instructions stored therein for causing a computer to execute a method comprising:
monitoring subnet usage within an internet service provider (ISP);
receiving a request for assignment to the ISP;
determining current assignment criteria for assignment of a user to a subnet within the ISP;
determining a best subnet assignment based on the current assignment criteria; and
assigning the user to the best subnet.

20. The computer readable medium of claim 19, wherein the current assignment criteria is determined from a predetermined combination of multiple criterions chosen from a group consisting of:
number of users, number of available addresses, bandwidth used, instantaneous bandwidth usage, available bandwidth, geographic area, expected usage, previous usage, and time-averaged usage.

21. The computer readable medium of claim 19, wherein monitoring is performed by using one method of a group consisting of:
number of users, number of available addresses, bandwidth used, instantaneous bandwidth usage, available bandwidth, geographic area, expected usage, previous usage, and time-averaged usage.

22. The computer readable medium of claim 19, wherein determining a best subnet assignment further comprises:
applying the current assignment criteria to the received request; and
determining which available subnet best fits the current assignment criteria.

23. The computer readable medium of claim 22, wherein determining which available subnet best fits the current assignment criteria comprises:
reviewing past usage data for the user from which the request is received; and
applying past usage information as a predictor of future usage data in determining the best available subnet.

24. A system for assigning users to an internet service provider (ISP) subnet, comprising:
an ISP server connectable to a subscriber network, the ISP server having memory, storage, and a processor; and
a computer readable medium, stored in storage and operable in the memory, the computer readable medium causing the server to perform intelligent assignment of users to the ISP according to a predetermined assignment plan.

25. The system of claim 24, wherein the predetermined assignment plan is implemented by a method comprising:
monitoring subnet usage for a plurality of subnets within the ISP;
receiving an assignment request from a user; and
assigning a subnet according to a distributed usage plan.

26. The system of claim 24, wherein the predetermined assignment plan is implemented by a method comprising:
monitoring subnet usage within an internet service provider (ISP);
receiving a request for assignment to the ISP;
determining current assignment criteria for assignment of a user to a subnet within the ISP;
determining a best subnet assignment based on the current assignment criteria; and
assigning the user to the best subnet.

27. The computer system of claim 24, and further comprising:
a plurality of ISP assignment databases stored in the storage, each assignment database storing assignment criteria for one of a plurality of ISPs.

28. The computer system of claim 27, and further comprising:
a router to route user requests to one of the plurality of assignment databases corresponding to the ISP to which the user is registered.

29. A computer system for administering an internet service provider, comprising:
a computer having a processor, a main memory, a mass storage device, and a network interface;
a computer program stored in storage and operable in the main memory by the processor, the program comprising instructions for causing the computer to perform a method comprising:
monitoring subnet usage within an internet service provider (ISP);
receiving a request for assignment to the ISP;
determining current assignment criteria for assignment of a user to a subnet within the ISP;
determining a best subnet assignment based on the current assignment criteria; and
assigning the user to the best subnet.

30. A subnet assignment system, comprising:
a computer having a network interface, a processor, a main memory, and a mass storage device;
a plurality of assignment databases stored in the mass storage device, each of the plurality of assignment databases corresponding to a particular internet service provider (ISP);
a router connected to the network interface and connectable to receive user requests and route the user requests to a requested one of the plurality of ISPs; and
a computer readable medium stored on the mass storage and executable by the processor in memory, the computer readable medium having instructions for causing the computer to perform a method comprising:
monitoring subnet usage within an internet service provider (ISP);
receiving a request for assignment to the ISP;
determining current assignment criteria for assignment of a user to a subnet within the ISP;
determining a best subnet assignment based on the current assignment criteria; and
assigning the user to the best subnet.
